(19) United States
(12) Patent Application Publication
(10) Pub. No.: US 2005/0021496 A1
(43) Pub. Date: Jan. 27, 2005

(54) System for handling data

(75) Inventor: Michael David Burke, London (GB)

Correspondence Address: WOOD, PHILLIPS, KATZ, CLARK & MORTIMER, 500 W. MADISON STREET, SUITE 3800, CHICAGO, IL, 60661, US

(73) Assignee: MCLAGAN Partners

(21) Appl. No.: 10/827,125

(22) Filed: Apr. 19, 2004

(30) Foreign Application Priority Data
Apr. 17, 2003 (GB) 0308992.7

(51) Int. Cl. G06F 17/30

(52) U.S. Cl. 707/1

(57) ABSTRACT

There is disclosed a system for handling and analysing data. The system is for providing an analysis of data, comprising means to assimilate static data, means to provide mapping of and a normalised structure of said data as a summary report, whereby to provide an enhanced analysis of said data, The system may be computer based.

The invention relates to a system for handling data.

Data is used in business and technology to provide for a variety of needs, for example bench-marking of business performance. Previous attempts at benchmarking have taken a survey based approach requesting that many participants complete a number of questionnaires. The results of these questionnaires are then analysed for trends and fed back to participants. Such approaches have associated problems, for example they are expensive, time-consuming and prone to error as data can be misused, misallocated or simply overlooked.

It is an object of tile invention to seek to mitigate these disadvantages.

According to the invention there is provided a system For providing an analysis of data, comprising means to assimilate static data, means to provide mappings of and a normalised structure of said data as a summary report, whereby to provide an enhanced analysis of said data.

The summary report may comprise a one page report. This provides an enhanced analysis and alloys direct use of the system in business management.

The system may be a computer-based system and the means to assimilate data may comprise a data base and graphical user interface whereby to normalise static data input. This is particularly advantageous, particularly where the graphical user interface may comprise drag and drop means whereby to display a normalised structure.

The means to provide mapping nay comprise a means to map static data into the system.

There may suitably be means to translate said static data and balances into the system.

There may also be sign off means adapted to define a noimalisation process. for example sign off sheet categories, which may be adapted to group input data and to replay said data for formal sign off.

There may also be dictionary means adapted to relate to nodal points of a structure, and include and/or exclude data related to discrete nodal points.

The said data may comprise product(s) and/or service(s) related to or associated with a discrete nodal point. It will be understood that a nodal point may be a cost centre of a business.

There may be a relational data base management system and a visual front end system, and the first mentioned system above may be at least part of the means to assimilate static data and may comprise a plurality of discrete store tables for data.

The store tables may comprise respectively tables to store source data, standardised structures and definitions, translated data, benchmarking results and/or allocations and security and/or audit functions.

The visual front end system may be adapted to manipulate data of the related data base management system.

The visual front end system may also comprise respective means for loading data, manipulation of standardised structures and definitions, mapping, translation of data into standardised format, calculation of results, reporting and administration,

The means for loading data may comprise means for handling data comprising static data, reporting structure, balance and metric data.

The means for administration may comprise means for providing security and/or audit trail facilitation,

The system may be adapted for benchmarking of a business, for example investment banking.

Using the invention it is possible to provide a high level summary of business results which can be used the better to target scarce resources at business change, which can be complemented by detailed reports for each node, or area, of a business. The methodology may incorporate a front water fall and a set of standard metrics.

A system for embodying the invention is hereinafter described, by way of example, with reference to the accompanying drawings.

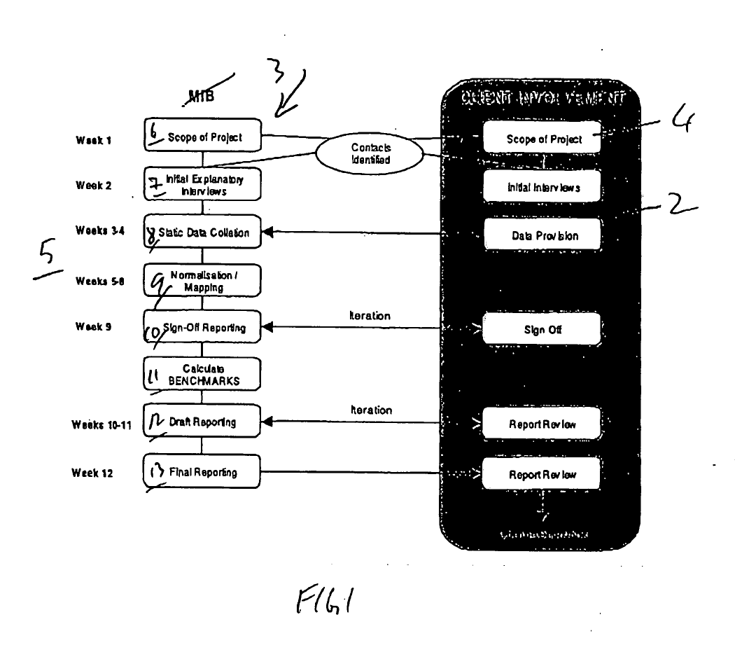

FIG. 1 is a graphical representation of a system according to the invention,

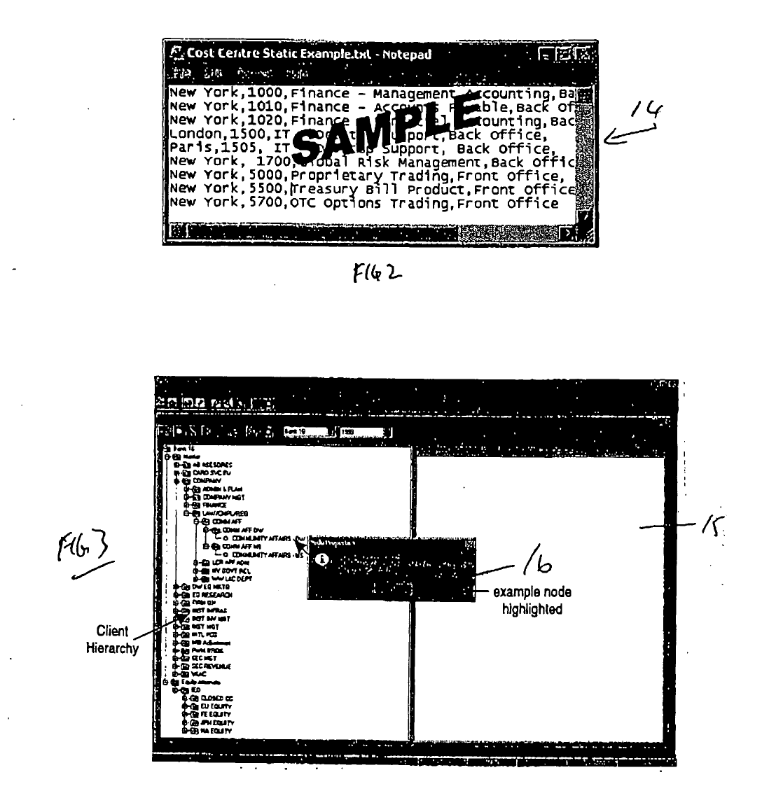

FIG. 2 is a representation of a sample screen;

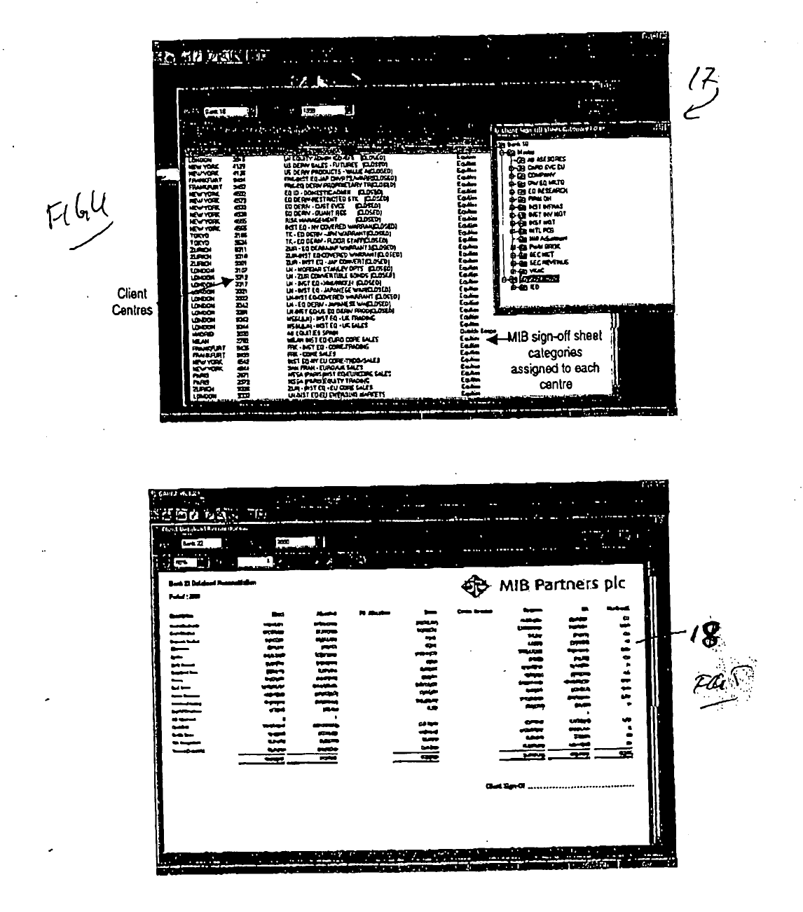

FIGS. 3 and 4 show respectively detailed screens used in the system;

FIG. 5 shows a screen of balance data;

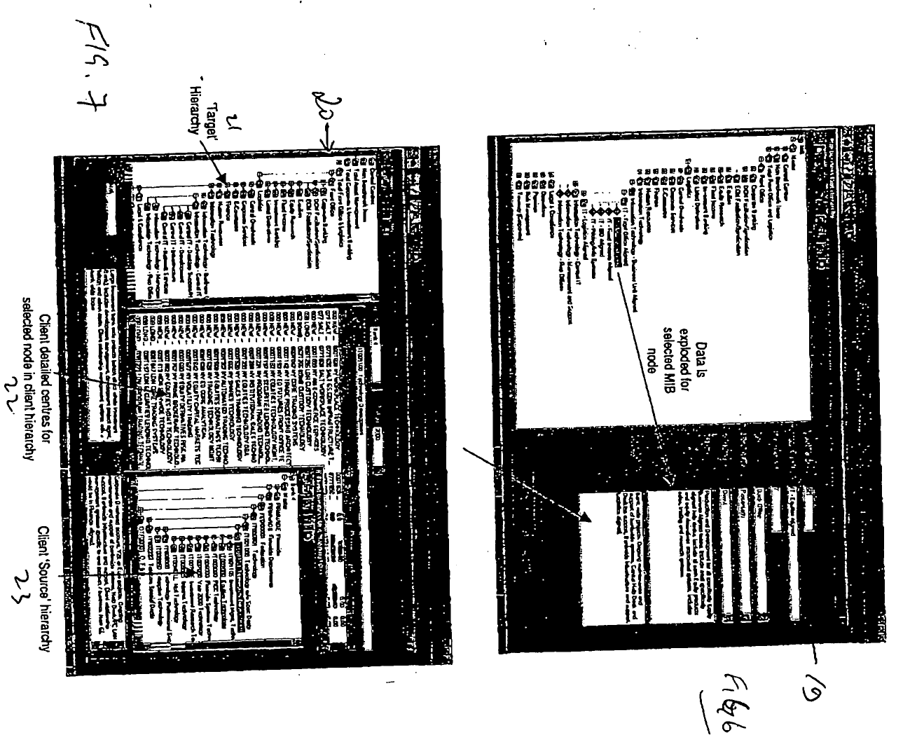

FIG. 6 shows a Master Business Unit hierarchy scheme;

FIG. 7 shows a typical mapping screen;

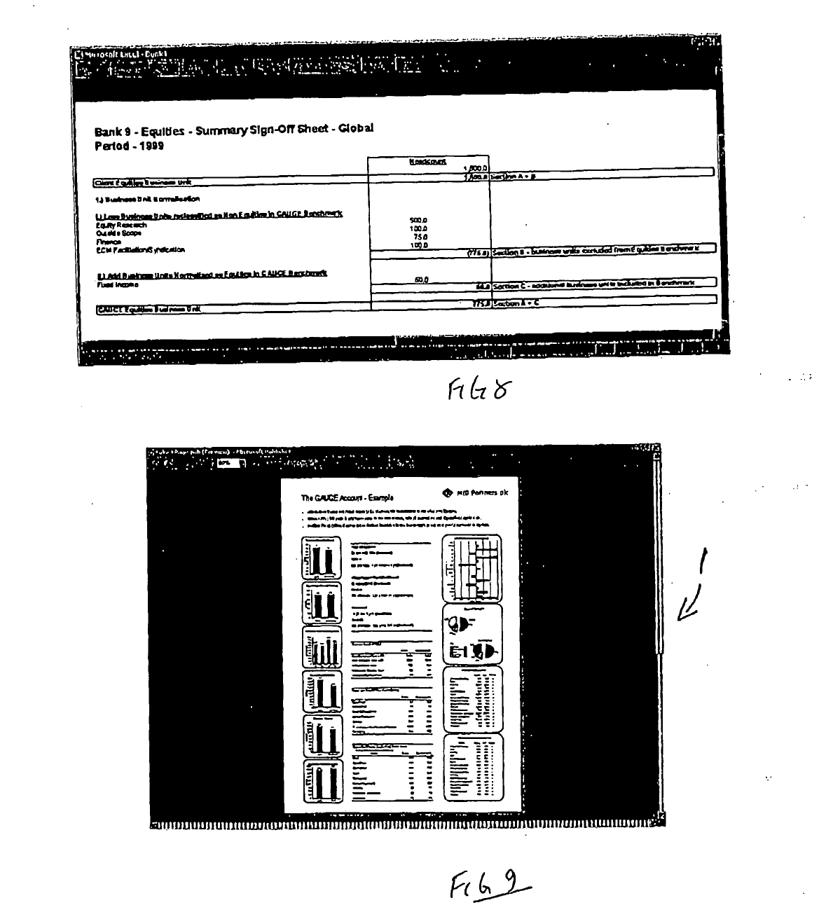

FIG. 8 shows an example of a summary report; and

FIG. 9 shows a single screen report.

Referring to the drawings, there is shown a system which is analysing data results in a single screen report which has a single screen 1, FIG. 9, which provides a technical solution to the problem of handling data concerning all aspects of a business or technology, for example investment banking or utilisation of nanotechnology.

In the following, investment banking is referred to, purely by way of example.

FIG. 1 shows a schematic of the main aspects of the system, where a client 2 provides to tile system 3 various data, for example basic data relating to the scope of the project 4, there being a time-line 5, for example week 1-week 12, for dealing with the input data from 2. The system 3 includes for example scope of project 6, initial explanatory interview 7, static data collation 8 by appropriate computer related means, normalisation and/or mapping 9, sign off reporting 10, calculation of benchmarks 11, draft reporting 12, and filial reporting 13.

Functions such as items 8, 10, 12 are two way functions between the input 2 and system 3, by way of iteration as appropriate.

The means for data loading will be enhanced in the system by dealing with a client to achieve via its staff at 7, a good understanding of data collation and the management process at 2.

The level to be used, medium for transfer, and scope of data will be discussed and agreed at the initial project planning sessions, 1, 2.

The data loads are divided into two main categories, static data and balance data.

Static Data

Static data consists to the atomic level data:
Cost Centres
Accounts
Locations

In addition to this base level data respective hierarchies are utilised to assist with the mapping process.

Where a client 2 does not have a gloval General Ledger, each of the regional GL's (or equivalent) will need to be loaded.

Any electronic format can be taken but the client 2 is encouraged to follow the guidelines outlined in a Data Take-on document to minimise inconsistencies. In the sample screen 14 (FIG. 2) the cast centre static has been provided in comma delimited text file format.

In addition to the cost centre, account and location static, information on headcount, headcount grades, and trade count will be gathered and included ill the system.

Once the static data and hierarchies have been loaded into the system 3, analysts at 3 may start reviewing the data. Alternate hierarchies may be loaded if they exist, as shown in screen 15, FIG. 3, where a particular node 16 is shown highlighted.

The next state in the system 2 is to categories the client's static data into high-level summary groupings e.g. Equities, Fixed Income, IT, Finance etc. These groupings, called sign-off sheet categories, are used during the sign-off process. The screen 17 shown in FIG. 4 relates to cost centre groupings caterogrised ,in a similar way.

Balance Data

Year-end balances, which include some of all of the following as relevant, are loaded by cost centre, account and location, e.g.
Direct costs
Allocated costs
Front Office Allocations
Bonus
Contra Revenue
Revenue

Headcount data is loaded by cost centre and location and includes
Year-end headcount—full time employees and contractors
Average/monthly headcount—full time employees and contractors
Headcount by grade including contractors

Average/monthly Headcount is captured to facilitate analysis of staff turnover during the year

Trade count is loaded at a later stage at sub-product level.

Once all balance data is loaded, a High Level Dataload Reconciliation report is produced using high level groupings (“sign-off sheet categories”). The high level numbers reconcile to tile client's 2 financial statements and the client 2 agrees both the cost centre and account groupings, as shown on screen 18, FIG. 5.

Normalisation/Mapping

To ensure a correct comparison, the system maps tile client's static (accounts, cost centres, and locations) into respective master structures. Such master structures are multi-tiered structures that allows reporting at varying levels of granularity.

Client data 2 is mapped to the lowest level possible. Analysis is normally provided at tile business unit level however where granularity exists at the lower levels, for all clients, this can be analysed.

For business units the system tracks from desk or support area up through to division, as shown for screen 19 (FIG. 6) which is an extract of a Master Business Unit hierarchy.

Each node in tile master structure is defined in terms of what is included and what is excluded. This helps ensure consistency between mappings.

Mapping Process

The client 2 hierarchies are used in the system in the mapping process. Where these hierarchies do not provide sufficient information or there is any ambiguity on the nature of the costs clarification is obtained from tile client at 2.

Balances and headcount numbers are available during the mapping process. These balances help eliminate defunct or immaterial static quickly.

A typical mapping screen 20 is shown in FIG. 7, which shows a target hierarchy 21, client selected node hierarchy 22 and client 2 source hierarchy 23.

The mapping process is an iterative process involving tile client to ensure mappings are appropriate and understood.

Sign-Off Process

Once the mapping process is complete, a series of summary and detailed audit reports are produced for the client 2 to sign-off 10. A separate report is produced for each of the high level groupings (“sign-off sheet categories”). All example Headcount summary report for Equities is shown at 24, FIG. 8.

The audit reports identify three different sections.
Section A includes those cost centres that both the client 2 and system define as the same i.e. in this example Equities.
Section B includes those centres that the client defines as Equities but that the system defines as non-Equities. E.g., Equities Product Control—mapped to Finance by the system.
Section C includes those centres that the client defines as non-Equities and the system defines as Equities E.g., Equity Derivatives—client 2 includes in Fixed Income.

Benchmark Calculation & Reporting

Once all the clients have signed off die Benchmark calculations are triggered. The system performs various control checks and reviews on the numbers following, which draft reports are produced. The draft reports 12 are sent to the clients 2 for review. If any discrepancies are found that require mapping changes, the Benchmarks are recalculated, the process starts again. Once all clients have reviewed the draft reports and are happy with the numbers, final reports 12 are produced with a management summary that includes the system's key findings and observations on the results. These are produced on a single screen 1.

Using the invention it is possible to provide an analysis of a business which comprises two main parts, a relational database management system (RDMS) and a visual basic front-end.

The database structure within RDMS has been developed after careful analysis of system requirements and has been updated through various iterations being formed of a number of tables used by the system to store the following
Participant source data i.e. static structures. balances, metrics etc.
Standardised structures and definitions
Translated participant data
Benchmarking, results Including allocations
Security and audit related

The visual basic front-end has been developed for manipulating the data within the RDMS database, It provides a range of functions that include;
Loading of participant data i.e. static, reporting structures, balance and metric data
Manipulation of the standardised structures and definitions
Mapping process
Translation of participant data into standardised format
Calculation of benchmark results including allocations
Reporting
Administration functions e.g. security, audit trails etc.

1. A system for providing an analysis of data, comprising means to assimilate static data, means to provide mapping of and a normalised structure of said data as a summary report, whereby to provide an enhanced analysis of said data.

2. A system according to claim 1, the summary report comprising a one page report.

3. A system according to claim 1, being a computer-based system, means to assimilate data comprising a data base and graphical user interface whereby to normalise static data input.

4. A system according to claim 3, the graphical user interface comprising drag and drop means whereby to display a normalised structure.

5. A system according to claim 4, the means to provide mapping comprising a means to map static data into the system.

6. A system according to claim 5, comprising means to translate said static data and balances into the system

7. A system according to claim 6, comprising sign off means adapted to define a normalisation process.

8. A system according to claim 7, the said means comprising sign off sheet categories.

9. A system according to claim 8, the sign off sheet categories being adapted to group input data and to replay said data for formal sign off.

10. A system according to claim 9, comprising dictionary means adapted to relate to nodal points of a structure, and include and/or exclude data related to discrete nodal points.

11. A system according to claim 10, the said data being related to product(s) and/or service(s) related to or associated with a discrete nodal point.

12. A system according to claim 1, comprising a relational data base management system and a visual front end system,

13. A system according to claim 12, the first mentioned system forming at least part of the means to assimilate static data and comprises a plurality of discrete store tables for data.

14. A system according to claim 13, the store tables comprising respectively tables to store source data. standardised structures and definitions, translated data, benchmarking results and/or allocations and security and/or audit functions.

15. A system according to claim 12, the visual front end system being adapted to manipulate data of the relationed data base management system.

16. A system according to claim 15, the visual front end system comprising respective means for loading data, manipulation of standardised structures and definitions, mapping, translation of data into standardised format, calculation of results, reporting and administration.

17. A system according to claim 16, the means for loading data comprising means for handling, data comprising static data, reporting structure, balance and metric data.

18. A system according to claim 16, the means for administration comprising means for providing security and/or audit trial facilitation

19. A system according to claim 1, adapted for benchmarking of a business.

20. A system according to claim 19, the business comprising investment banking.
